(19) United States
(12) Patent Application Publication
(10) Pub. No.: US 2020/0013190 A1
(43) Pub. Date: Jan. 9, 2020

(54) APPARATUS AND METHOD FOR RECOGNIZING OBJECT IN IMAGE

(71) Applicant: LG ELECTRONICS INC., Seoul (KR)

(72) Inventors: Ruei Hung LI, Seoul (KR); Sang Hoon KIM, Seoul (KR); Jin Gyeong KIM, Seoul (KR); Jin Seok IM, Seongnam-si (KR)

(73) Assignee: LG ELECTRONICS INC., Seoul (KR)

(21) Appl. No.: 16/577,973

(22) Filed: Sep. 20, 2019

(30) Foreign Application Priority Data
Jul. 26, 2019 (KR) 10-2019-0091090

(51) Int. Cl. G06T 7/73; G06K 9/32; G06T 7/246; G06T 11/00; G06T 7/90

(52) U.S. Cl. CPC G06T 7/74; G06K 9/3241; G06T 2207/20084; G06T 11/00; G06T 7/90; G06T 7/248

(57) ABSTRACT

An apparatus and a method for recognizing an object in an image are disclosed. The method for recognizing an object in an image may include: executing a deep neural network algorithm which has been trained in advance to recognize an object in an image, on a first image inputted from a camera module; finding an amount of change in image between the first image and a second image inputted from the camera module after the first image according to a predetermined cycle; and in response that an object has been detected from the first image as a result of executing the deep neural network algorithm, tracking the position of the detected object from the second image, based on the found amount of change in image.

### CROSS-REFERENCE TO RELATED APPLICATION

Pursuant to 35 U.S.C. § 119(a), this application claims the benefit of earlier filing date and right of priority to Korean Patent Application No. 10-2019-0091090, filed on Jul. 26, 2019, the contents of which are hereby incorporated by reference herein in its entirety.

### BACKGROUND

### Field of the Invention

The present disclosure relates to an apparatus and a method for recognizing an object in an image, which detects a moving object from a plurality of images and tracks the position of the detected object, by using an optical flow, in conjunction with a deep neural network (DNN) algorithm.

### Description of Related Art

A deep learning-based object recognition method may detect an object in an image and track the position of the object, through a pre-trained deep neural network algorithm. However, the deep learning-based object recognition method requires a large number of computations, and therefore requires a high-performance computing device and power consumption.

In addition, in the deep learning-based object recognition method, as the number of images increases or the resolution of the image increases, the number of computations used in the deep neural network algorithm increases rapidly, and thus the speed of executing the computations may be slowed.

The related art discloses a method for detecting an object based on an artificial intelligence deep learning technology for an image captured by a surveillance camera, wherein the method may track the object by using deep learning networks for detecting, recognizing, and tracking. The related art uses a plurality of deep learning networks to track an object from an image, thereby also increasing the number of computations used.

Therefore, there is a need for a technology capable of tracking the position of an object while using a relatively small number of computations.

### RELATED ART DOCUMENT

### Patent Document

Related Art: Korean Patent Application Publication No. 10-2018-0107930

### SUMMARY OF THE INVENTION

According to the present disclosure, a deep neural network algorithm is executed on an inputted image, and when an object is detected from the image, an optical flow using a smaller number of computations compared to the deep neural network algorithm is executed on a subsequently inputted image to track the position of the object, such that even if the number of images increases, it is possible to track the position of the object by using a relatively small number of computations.

In addition, according to the present disclosure, an optical flow is executed on an inputted image to identify a region where an object may be present, and a deep neural network algorithm is executed on the identified region, such that the deep neural network algorithm is executed on a limited region instead of the entire region of the image, thereby further reducing the number of computations used.

An embodiment of the present disclosure is directed to a method for recognizing an object in an image, the method including: executing a deep neural network (DNN) algorithm which has been trained in advance to recognize an object in an image, on a first image inputted from a camera module; finding an amount of change in image between the first image and a second image inputted from the camera module after the first image according to a predetermined cycle; and in response that an object has been detected from the first image as a result of executing the deep neural network algorithm, tracking the position of the detected object from the second image, based on the found amount of change in image.

According to an embodiment of the present disclosure, the method further includes, after the finding an amount of change in image, determining the reliability of the result of finding the amount of change in image, wherein the tracking the position of the detected object includes: in response that the result of determining the reliability indicates that the reliability of the result of finding the amount of change in image is lower than a predetermined threshold, estimating the position of the object based on the result of finding the amount of change in image and setting a first region of interest in the second image to include the estimated position of the object; and tracking the position of the object from the second image by executing the deep neural network algorithm on the set first region of interest.

According to an embodiment of the present disclosure, the finding an amount of change in image includes calculating a motion vector by using an optical flow to find the amount of change in image.

According to an embodiment of the present disclosure, the method further includes, after the finding an amount of change in image, determining the reliability of the result of finding the amount of change in image, wherein the calculating a motion vector by using an optical flow includes: calculating a motion vector for each pixel in the first image and the second image, based on a result of comparing the first image and the second image, and obtaining a color corresponding to the direction of the motion vector in consideration of a color predetermined for each direction; and generating an optical flow image, based on the color corresponding to the motion vector for each pixel, and wherein the determining the reliability includes: identifying an object region corresponding to the object in the optical flow image; and based on that a pixel having a color indicating an error exists above a reference value in the object region, determining that the reliability of the result of finding the amount of change in image is less than a predetermined threshold.

According to an embodiment of the present disclosure, the method further includes, after the finding an amount of change in image, determining the reliability of the result of finding the amount of change in image, wherein the calculating a motion vector by using an optical flow includes: calculating a motion vector for each pixel in the first image and the second image, based on a result of comparing the first image and the second image, and obtaining a color corresponding to the direction of the motion vector in consideration of a color predetermined for each direction; and generating an optical flow image, based on the color corresponding to the motion vector for each pixel, and wherein the determining the reliability includes: identifying an object region corresponding to the object in the optical flow image; and based on that the number of color types determined for the pixels in the object region is greater than or equal to a predetermined value, determining that the reliability of the result of finding the amount of change in image is less than a predetermined threshold.

According to an embodiment of the present disclosure, the method further includes: after the finding an amount of change in image, in response that the object has not been detected from the first image, checking that there is a motion of a new object based on the result of finding the amount of change in image; based on confirmation that there is a motion of the new object as a result of the checking, setting a second region of interest in the second image to include the position of the new object; and detecting the new object from the second image by executing the deep neural network algorithm on the set second region of interest.

According to an embodiment of the present disclosure, the tracking the position of the detected object includes: obtaining an initial position of the object from the result of executing the deep neural network algorithm and obtaining a moving distance of the object from the result of finding the amount of change in image; and tracking the position of the object based on the moving distance of the object and the initial position of the object.

According to an embodiment of the present disclosure, the method further includes calculating a moving speed of the object by using the moving distance of the object and the cycle, and in response that the moving speed of the object is greater than or equal to a predetermined speed, generating a warning notification.

According to an embodiment of the present disclosure, the method further includes tracking the position of the object by finding an amount of change in image for a plurality of images inputted after the second image and executing the deep neural network algorithm instead of finding the amount of change in image, per a predetermined period.

According to an embodiment of the present disclosure, the method further includes, based on determination that the object is in a “stopped state” as a result of tracking the position of the object, increasing the cycle for finding the amount of change in image by a predetermined time.

An embodiment of the present disclosure is directed to an apparatus for recognizing an object in an image, the apparatus including: an executor configured to execute a deep neural network algorithm which has been trained in advance to recognize an object in an image, on a first image inputted from a camera module, and find an amount of change in image between the first image and a second image inputted from the camera module after the first image according to a predetermined cycle; and a processor configured to, in response that an object has been detected from the first image as a result of executing the deep neural network algorithm, track the position of the detected object from the second image, based on the found amount of change in image.

According to an embodiment of the present disclosure, the apparatus further includes a determiner configured to determine the reliability of the result of finding the amount of change in image, wherein the processor includes: a setter configured to, in response that the result of determining the reliability indicates that the reliability of the result of finding the amount of change in image is lower than a predetermined threshold, estimate the position of the object based on the result of finding the amount of change in image, and set a first region of interest in the second image to include the estimated position of the object; and a tracker configured to track the position of the object from the second image by executing the deep neural network algorithm on the set first region of interest.

According to an embodiment of the present disclosure, the executor is configured to calculate a motion vector by using an optical flow to find the amount of change in image.

According to an embodiment of the present disclosure, the apparatus further includes a determiner configured to determine the reliability of the result of finding the amount of change in image, wherein the executor is configured to: calculate a motion vector for each pixel in the first image and the second image, based on a result of comparing the first image and the second image; obtain a color corresponding to the direction of the motion vector in consideration of a color predetermined for each direction; and thereafter, generate an optical flow image based on the color corresponding to the motion vector for each pixel, wherein the determiner is configured to: identify an object region corresponding to the object in the optical flow image; and based on that a pixel having a color indicating an error exists above a reference value in the object region, determine that the reliability of the result of finding the amount of change in image is less than a predetermined threshold.

According to an embodiment of the present disclosure, the apparatus further includes a determiner configured to determine the reliability of the result of finding the amount of change in image, wherein the executor is configured to: calculate a motion vector for each pixel in the first image and the second image, based on a result of comparing the first image and the second image; obtain a color corresponding to the direction of the motion vector in consideration of a color predetermined for each direction; and thereafter, generate an optical flow image, based on the color corresponding to the motion vector for each pixel, and wherein the determiner is configured to: identify an object region corresponding to the object in the optical flow image; and based on that the number of color types determined for the pixels in the object region is greater than or equal to a predetermined value, determine that the reliability of the result of finding the amount of change in image is less than a predetermined threshold.

According to an embodiment of the present disclosure, the processor includes: a setter configured to, in response that the object has not been detected from the first image, check that there is a motion of a new object based on the result of finding the amount of change in image, and based on confirmation that there is a motion of the new object as a result of the check, set a second region of interest in the second image to include the position of the new object; and a tracker configured to detect the new object from the second image by executing the deep neural network algorithm on the set second region of interest.

According to an embodiment of the present disclosure, the processor is configured to track the position of the object by finding an amount of change in image for a plurality of images inputted after the second image and execute the deep neural network algorithm instead of finding the amount of change in image, per a predetermined period, and the predetermined period is defined longer than the cycle.

According to an embodiment of the present disclosure, the processor is configured to, based on determination that the object is in a “stopped state” as a result of tracking the position of the object, increase the cycle for finding the amount of change in image by a predetermined time.

According to the present disclosure, a deep neural network algorithm is executed on an inputted image, and when an object is detected from the image, an optical flow using a smaller number of computations compared to the deep neural network algorithm is executed on a subsequently inputted image to track the position of the object, such that even if the number of images increases, it is possible to track the position of the object by using a relatively small number of computations.

In addition, according to the present disclosure, an optical flow is executed on an inputted image to identify a region where an object may be present, and a deep neural network algorithm is executed on the identified region, such that the deep neural network algorithm is executed on a limited region instead of the entire region of the image, thereby further reducing the number of computations used.

### BRIEF DESCRIPTION OF THE DRAWINGS

FIG. 1 is a diagram illustrating a configuration of an apparatus for recognizing an object in an image according to an embodiment of the present disclosure.

FIG. 2 is a diagram illustrating an example of detecting an object from an image by executing a deep neural network algorithm on the image, in the apparatus for recognizing an object in an image according to an embodiment of the present disclosure.

FIG. 3 is a diagram illustrating an example of using an optical flow to find an amount of change in image between images, in the apparatus for recognizing an object in an image according to an embodiment of the present disclosure.

FIG. 4 is a diagram illustrating an example of detecting an object from an image by executing a deep neural network algorithm on some regions in the image, in the apparatus for recognizing an object in an image according to an embodiment of the present disclosure.

FIG. 5 is a diagram illustrating an example of detecting a new object from an image by executing a deep neural network algorithm on some regions in the image, in the apparatus for recognizing an object in an image according to an embodiment of the present disclosure.

FIG. 6 is a flowchart illustrating a method for recognizing an object from an initial image, in the apparatus for recognizing an object in an image according to an embodiment of the present disclosure.

FIG. 7 is a flowchart illustrating a method for recognizing an object from a subsequent image inputted after an initial image, in the apparatus for recognizing an object in an image according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. In the following description, the suffixes “module” and “unit” that are mentioned with respect to the elements used in the present description are merely used individually or in combination for the purpose of simplifying the description of the present invention, and therefore, the suffix itself will not be used to differentiate the significance or function or the corresponding term. Further, in the description of the embodiments of the present disclosure, when it is determined that the detailed description of the related art would obscure the gist of the present disclosure, the description thereof will be omitted. Also, the accompanying drawings are provided only to facilitate understanding of the embodiments disclosed in the present disclosure and therefore should not be construed as being limiting in any way. It should be understood that all modifications, equivalents, and replacements which are not exemplified herein but are still within the spirit and scope of the present disclosure are to be construed as being included in the present disclosure.

The terms such as “first,” “second,” and other numerical terms may be used herein only to describe various elements and only to distinguish one element from another element, and as such, these elements should not be limited by these terms.

Similarly, it will be understood that when an element is referred to as being “connected,” “attached,” or “coupled” to another element, it can be directly connected, attached, or coupled to the other element, or intervening elements may be present. In contrast, when an element is referred to as being “directly connected,” “directly attached,” or “directly coupled” to another element, no intervening elements are present.

As used herein, the singular forms “a,” “an,” and “the” may be intended to include the plural forms as well, unless the context clearly indicates otherwise.

The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof.

A vehicle described herein may be a concept including an automobile and a motorcycle. In the following, the vehicle will be described mainly as an automobile.

The vehicle described herein may be a concept including, for example, all of an internal combustion engine vehicle having an engine as a power source, a hybrid vehicle having an engine and an electric motor as a power source, and an electric vehicle having an electric motor as a power source.

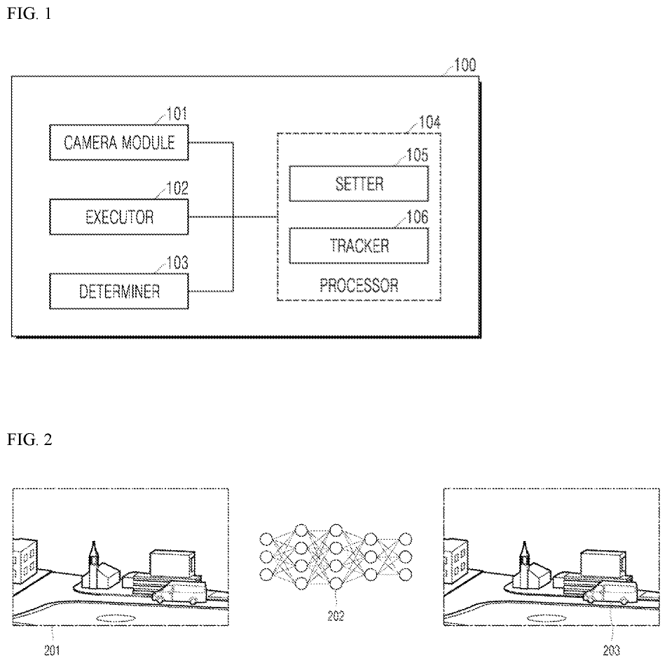

FIG. 1 is a diagram illustrating a configuration of an apparatus for recognizing an object in an image according to an embodiment of the present disclosure.

Referring to FIG. 1, an apparatus 100 for recognizing an object in an image according to an embodiment of the present disclosure may include a camera module 101, an executor 102, a determiner 103, and a processor 104.

The camera module 101 may generate an image according to a predetermined cycle. Here, the camera module 101 may generate an image by photographing an object at the same position at the same angle per a predetermined cycle, and transmit the generated image to the executor 102 in sequence.

The executor 102 may execute a process for detecting an object (for example, a vehicle) from the image from the camera module 101.

Specifically, the executor 102 may execute a deep neural network algorithm which has been trained in advance to recognize an object in an image, on a first image inputted from the camera module 101.

In addition, the executor 102 may find an amount of change in image between the first image and a second image inputted from the camera module 101 after the first image according to a predetermined cycle. Here, the executor 102 may calculate a motion vector by using an optical flow to find the amount of change in image. Specifically, the executor 102 may calculate a motion vector for each pixel in the first image and the second image, based on a result of comparing the first image and the second image. The executor 102 may obtain a color corresponding to the direction of the motion vector in consideration of a color predetermined for each direction (for example, 3 o'clock: red, 9 o'clock: blue), and obtain a color intensity corresponding to the size of the motion vector in consideration of a color intensity predetermined for each distance (for example, the color intensifies as the distance increases). The executor 102 may then generate an optical flow image based on the color and the color intensity corresponding to the motion vector for each pixel.

The determiner 103 may determine the reliability of the result of finding the amount of change in image between the first image and the second image. Here, the determiner 103 may identify an object region corresponding to the object in the optical flow image, and based on that a pixel having a color (for example, black) indicating an error exists above a reference value in the object region, determine that the reliability of the result of finding the amount of change in image is less than a predetermined threshold.

As another example of determining the reliability, the determiner 103 may identify an object region corresponding to the object in the optical flow image, and based on that the number of color types determined for the pixels in the object region is greater than or equal to a predetermined value (for example, five), determine that the reliability of the result of finding the amount of change in image is less than a predetermined threshold. That is, when each pixel has different colors in the object region in the optical flow image, (which denotes motion distribution in different directions), the determiner 103 may determine that it is not suitable to use the optical flow image to track the position of the object.

The processor 104 may detect an object from the first image based on the result of executing the deep neural network algorithm. Here, when detecting the object, the processor 104 may also detect the type and position of the object.

In addition, in response that an object has been detected from the first image as a result of executing the deep neural network algorithm, the processor 104 may track the position of the detected object from the second image, based on the amount of change in image between the first image and the second image. Here, the processor 104 may obtain an initial position of the object from the result of executing the deep neural network algorithm, and obtain a moving distance of the object from the result of finding the amount of change in image. The processor 104 may then track the position of the object based on the moving distance of the object and the initial position of the object.

The processor 104 may calculate a moving speed of the object by using the moving distance of the object and the cycle in which an image is generated in the camera module 101 (or the cycle in which an image is inputted from the camera module), and in response that the moving speed of the object is greater than or equal to a predetermined speed, generate a warning notification to avoid the object, thereby preventing in advance an accident that may occur due to the object.

According to the result of determining the reliability of the result of finding the amount of change in image in the determiner 103, the processor 104 may use the amount of change in image between the first image and the second image, or use the deep neural network algorithm on some regions in the second image, when tracking the position of the object. That is, in response that the result of determining the reliability indicates that the reliability of the result of finding the amount of change in image is greater than or equal to a predetermined threshold, the processor 104 may recognize that the amount of change in image is sufficient to track the position of the object, and track the position of the detected object based on the amount of change in image between the first image and the second image.

On the other hand, in response that the result of determining the reliability indicates that the reliability of the result of finding the amount of change in image is lower than a predetermined threshold, the processor 104 may recognize that the amount of change in image is not sufficient to track the position of the object, and track the position of the detected object by using the deep neural network algorithm on some regions in the second image.

The processor 104 may include a setter 105 and a tracker 106.

In response that the result of determining the reliability of the result of finding the amount of change in image in the determiner 103 indicates that the reliability of the result of finding the amount of change in image is lower than a predetermined threshold, the setter 105 may estimate the position of the object based on the result of finding the amount of change in image, and set a first region of interest in the second image to include the estimated position of the object.

In addition, in response that the object has not been detected from the first image, the setter 105 may check that there is a motion of a new object based on the result of finding the amount of change in image. Based on confirmation that there is a motion of the new object as a result of the check, the setter 105 may set a second region of interest in the second image to include the position of the new object.

When the first region of interest is set in the second image by the setter 105, the tracker 106 may execute the deep neural network algorithm on the set first region of interest, and based on the execution result, track the position of the object from the second image.

In addition, when the second region of interest is set in the second image by the setter 105, the tracker 106 may execute the deep neural network algorithm on the set second region of interest, and based on the execution result, detect the new object from the second image. Here, when detecting the new object, the tracker 106 may also detect the type and position of the new object.

In addition, the processor 104 may find, for plurality of images inputted after the second image, an amount of change in image (an amount of change in image between the plurality of images, or an amount of change in image between the first image and each image of the plurality of images) through the executor 102, to track the position of the object. Here, the processor 104 may execute the deep neural network algorithm instead of finding the amount of change in image, per a predetermined period, thereby accurately tracking the position of the object while reducing the number of computations used. Here, the predetermined period may be defined longer than the cycle in which the image is inputted.

For example, the processor 104 may execute the deep neural network algorithm on an inputted image every 30 seconds. Specifically, the processor 104 may execute the deep neural network algorithm on the first image, and when 30 seconds elapses as the optical flow is executed on the second to tenth images to find the amount of change in image, execute the deep neural network algorithm on the eleventh image. Here, when the second image is inputted, the processor 104 may execute the optical flow to find an amount of change in image between the second image and the first image which is the previous image, thereby tracking the position of the object from the second image. In addition, when the third image is inputted, the processor 104 may execute the optical flow to find an amount of change in image between the third image and the second image which is the previous image (or between the third image and the first image on which the deep neural network algorithm has been executed), thereby tracking the position of the object from the third image. On the other hand, when the eleventh image is inputted, the processor 104 may execute the deep neural network algorithm on the eleventh image to track the position of the object from the eleventh image.

In addition, as a result of tracking the position of the object, when it is determined that the object is in a “stopped state,” the processor 104 may increase the cycle of finding the amount of change in image (or the cycle in which the image is generated by the camera module 101) by a predetermined time, and thus the number of images to be processed may be reduced, thereby reducing the number of computations used. Here, the processor 104 may determine the object as being in the “stopped state” when a pixel having a color (for example, white) indicating a stoppage exists above a reference value in the optical flow image.

According to an embodiment of the present disclosure, when an object is detected in a previously inputted image by using a deep neural network algorithm which has been trained in advance to recognize an object in an image, the apparatus 100 for recognizing an object in an image may track the position of the object by using an optical flow using a smaller number of computations compared to the deep neural network algorithm, for the image inputted after the previously inputted image, thereby accurately tracking the position of the object with a relatively small number of computations used.

In addition, the apparatus 100 for recognizing an object in an image according to an embodiment of the present disclosure may include the camera module 101 but is not limited thereto. The apparatus 100 may receive an image periodically from an externally located camera module and track the position of the object from the received image.

The apparatus 100 for recognizing an object in an image according to an embodiment of the present disclosure may be applied to, for example, an autonomous vehicle, and may effectively detect a new vehicle and track the position thereof from an image photographing a driving view.

FIG. 2 is a diagram illustrating an example of detecting an object from an image by executing a deep neural network algorithm on the image, in the apparatus for recognizing an object in an image according to an embodiment of the present disclosure.

Referring to FIG. 2, when a first image 201 is inputted from the camera module, the apparatus for recognizing an object in an image may execute, on the inputted first image 201, a deep neural network algorithm 202 which has been trained in advance to recognize an object in an image, so as to detect a vehicle 203 as an object from the first image 201. Here, the apparatus for recognizing an object in an image may also obtain the type (for example, vehicle) and the position of the object.

Here, when the first image 201 is inputted as an input value, the deep neural network algorithm 202 may output the vehicle 203 in the first image 201 as an output value.

A deep neural network algorithm with a plurality of hidden layers between the input layer and the output layer may be the most representative type of artificial neural network which enables deep learning and which is one machine learning technique.

An ANN can be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

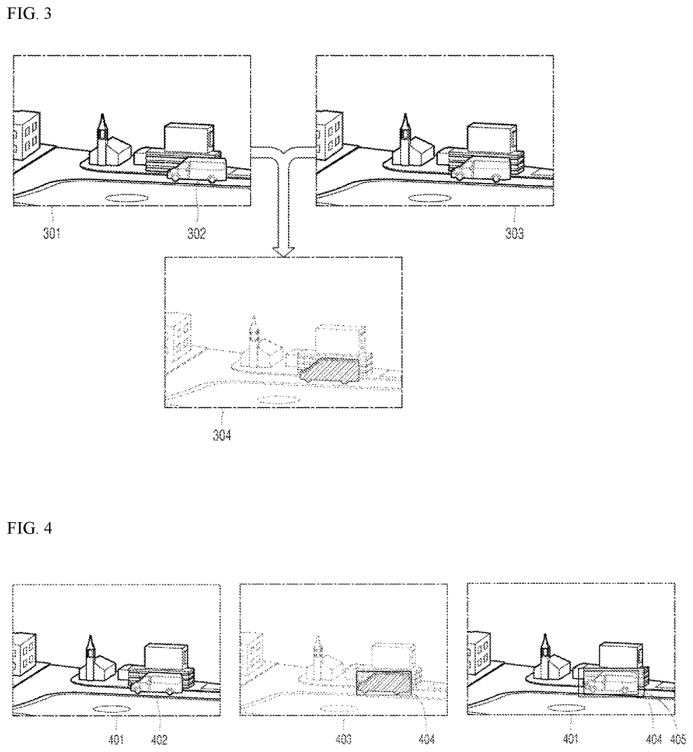

FIG. 3 is a diagram illustrating an example of using an optical flow to find an amount of change in image between images, in the apparatus for recognizing an object in an image according to an embodiment of the present disclosure.

Referring to FIG. 3, after detecting a vehicle 302 from a first image 301 by using a deep neural network algorithm, when a second image 303 is inputted from the camera module according to a predetermined cycle, the apparatus for recognizing an object may find an amount of change in image between the first image 301 and the second image 303, and based on the found amount of change in image, track, in the second image 303, the position of the vehicle 302 detected from the first image 301.

Here, the apparatus for recognizing an object in an image may calculate a motion vector by using an optical flow to find the amount of change in image. Specifically, the apparatus for recognizing an object in an image may calculate a motion vector for each pixel in the first image 301 and the second image 303, based on a result of comparing the first image 301 and the second image 303. The apparatus for recognizing an object in an image may obtain a color corresponding to the direction of the motion vector in consideration of a color predetermined for each direction (for example, 3 o'clock: red, 9 o'clock: blue), and obtain a color intensity corresponding to the size of the motion vector in consideration of a color intensity predetermined for each distance (for example, the color intensifies as the distance increases). The apparatus for recognizing an object in an image may then generate an optical flow image 304 based on the color and the color intensity corresponding to the motion vector for each pixel, and track the position of the vehicle 302 based on the type of color and the color intensity of each pixel in the optical flow image 304.

When generating the optical flow image, the apparatus for recognizing an object in an image may generate, for example, “white” which is a color representing a stoppage, for a pixel that has not moved between the first image 301 and the second image 303, and generate, for example, “black” which is a color representing an error, for a pixel for which the motion vector has not been calculated.

FIG. 4 is a diagram illustrating an example of detecting an object from an image by executing a deep neural network algorithm on some regions in the image, in the apparatus for recognizing an object in an image according to an embodiment of the present disclosure.

Referring to FIG. 4, after detecting a vehicle from a first image (not shown) by using a deep neural network algorithm, when a second image 401 is inputted from the camera module according to a predetermined cycle, the apparatus for recognizing an object in an image may find an amount of change in image between the first image and the second image 401, and based on the found amount of change in image, track the position of the vehicle 402 detected from the first image.

Here, when the vehicle 402 is detected from the first image by using the deep neural network algorithm, but the reliability of the result of finding the amount of change in image between the first image and the second image 401 is lower than a predetermined threshold, the apparatus for recognizing an object in an image may execute the deep neural network algorithm on some regions in the second image 401 where the vehicle 402 may be present.

Specifically, the apparatus for recognizing an object in an image may estimate the position of the vehicle based on the result of finding the amount of change in image between the first image and the second image 401. Here, the apparatus for recognizing an object in an image may calculate a motion vector for each pixel in the first image and the second image 401 by using the optical flow to find the amount of change in image, and generate an optical flow image 403 based on the direction and size of the calculated motion vector. The apparatus for recognizing an object in an image may then estimate the position 404 of the vehicle in the optical flow image 403, and set a first region of interest 405 in the second image 401 to include the estimated position 404 of the vehicle. The apparatus for recognizing an object in an image may track the position of the vehicle 402 from the second image 401 by executing the deep neural network algorithm on the first region of interest 405.

The apparatus for recognizing an object in an image may execute the deep neural network algorithm on a limited region where the object may be present, that is, the first region of interest 405, instead of the entire second image 401, thereby reducing the number of computations used compared to executing the deep neural network algorithm on the entire second image 401.

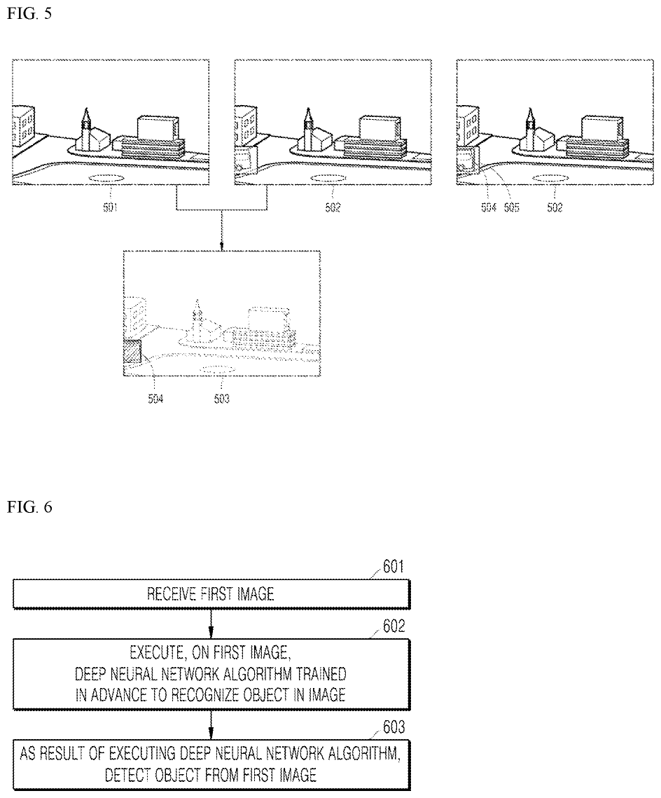

FIG. 5 is a diagram illustrating an example of detecting a new object from an image by executing a deep neural network algorithm on some regions in the image, in the apparatus for recognizing an object in an image according to an embodiment of the present disclosure.

Referring to FIG. 5, after receiving a first image 501, when a second image 502 is inputted from the camera module, the apparatus for recognizing an object in an image may find an amount of change in image between the first image 501 and the second image 502, and when a vehicle (not shown) has been detected from the first image 501, track the position of the vehicle detected from the first image 501, based on the found amount of change in image. Here, the apparatus for recognizing an object in an image may calculate a motion vector for each pixel in the first image 501 and the second image 502 by using the optical flow to find the amount of change in image, and generate an optical flow image 503 based on the direction and size of the calculated motion vector.

When the vehicle has not been detected from the first image 501, the apparatus for recognizing an object in an image may check that there is a motion of a new object based on the amount of change in image between the first image 501 and the second image 502.

Based on confirmation that there is a motion of a new vehicle as a new object based on the optical flow image 503, the apparatus for recognizing an object in an image may estimate the position 504 of the new vehicle from the optical flow image 503, and set a second region of interest 505 in the second image 502 to include the estimated position 504 of the new vehicle.

The apparatus for recognizing an object in an image may detect the new vehicle from the second image 502 by executing the deep neural network algorithm on the second region of interest 505. Here, when the new vehicle is detected, the apparatus for recognizing an object in an image may detect the position of the new vehicle.

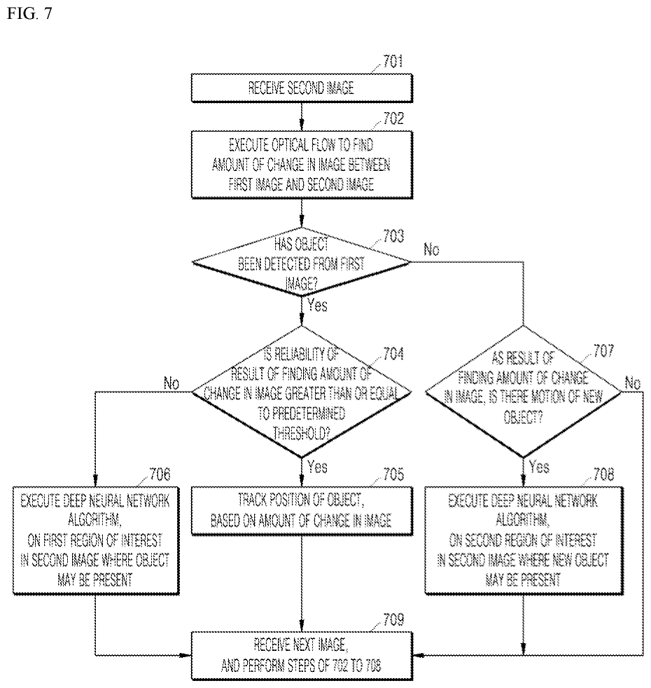

Hereinafter, a method for recognizing an object in an image according to an embodiment of the present disclosure will be described with reference to FIGS. 6 and 7. Here, the apparatus for recognizing an object in an image, which performs the method for recognizing an object in an image, may receive an image generated by an externally located camera module or generate an image by using an internally located camera module, per a predetermined cycle.

FIG. 6 is a flowchart illustrating a method for recognizing an object from an initial image, in the apparatus for recognizing an object in an image according to an embodiment of the present disclosure.

Referring to FIG. 6, in step 601, the apparatus for recognizing an object in an image may receive a first image as an initial image inputted from a camera module.

In step 602, the apparatus for recognizing an object in an image executes, on the first image, a deep neural network algorithm which has been trained in advance to recognize an object in an image.

In step 603, the apparatus for recognizing an object in an image may detect an object from the first image as a result of executing the deep neural network algorithm. Here, when detecting the object, the apparatus for recognizing an object in an image may also detect the type and position of the object.

FIG. 7 is a flowchart illustrating a method for recognizing an object from a subsequent image inputted after an initial image, in the apparatus for recognizing an object in an image according to an embodiment of the present disclosure.

Referring to FIG. 7, in step 701, the apparatus for recognizing an object in an image may receive a second image as a subsequent image generated after the initial image by the camera module.

In step 702, the apparatus for recognizing an object in an image may find an amount of change in image between a first image inputted as the initial image and the second image inputted as the subsequent image. Here, the apparatus for recognizing an object in an image may calculate a motion vector by using an optical flow to find the amount of change in image. Specifically, the apparatus for recognizing an object in an image may calculate a motion vector for each pixel in the first image and the second image, based on a result of comparing the first image and the second image.

The apparatus for recognizing an object in an image may then obtain a color corresponding to the direction of the motion vector in consideration of a color predetermined for each direction (for example, 3 o'clock: red, 9 o'clock: blue), and obtain a color intensity corresponding to the size of the motion vector in consideration of a color intensity predetermined for each distance (for example, the color intensifies as the distance increases). The apparatus for recognizing an object in an image may generate an optical flow image, based on the color and the color intensity corresponding to the motion vector for each pixel.

In step 703, when the object has been detected from the first image as a result of executing the deep neural network algorithm on the first image, the apparatus for recognizing an object in an image may check whether the amount of change in image is sufficient to track the position of the object by determining the reliability of the result of finding the amount of change in image.

Here, the apparatus for recognizing an object in an image may identify an object region corresponding to the object in the optical flow image, and based on that a pixel having a color (for example, black) indicating an error exists above a reference value in the object region, determine that the reliability of the result of finding the amount of change in image is less than a predetermined threshold.

As another example, the apparatus for recognizing an object in an image may identify an object region corresponding to the object in the optical flow image, and based on that the number of color types determined for the pixels in the object region is greater than or equal to a predetermined value (for example, five), determine that the reliability of the result of finding the amount of change in image is less than a predetermined threshold. That is, when each pixel has different colors in the object region in the optical flow image, (which denotes motion distribution in different directions), the apparatus for recognizing an object in an image may determine that it is not suitable to use the optical flow image to track the position of the object.

In step 704, when the reliability of the result of finding the amount of change in image is greater than or equal to a predetermined threshold, the apparatus for recognizing an object in an image may recognize that the amount of change in image is sufficient to track the position of the object, and in step 705, track the position of the detected object based on the amount of change in image between the first image and the second image. Here, the apparatus for recognizing an object in an image may obtain an initial position of the object from the result of executing the deep neural network algorithm, and obtain a moving distance of the object from the result of finding the amount of change in image. The apparatus for recognizing an object in an image may then track the position of the object based on the moving distance of the object and the initial position of the object.

The apparatus for recognizing an object in an image may calculate a moving speed of the object by using the moving distance of the object and the cycle, and in response that the moving speed of the object is greater than or equal to a predetermined speed, generate a warning notification to avoid the object, thereby preventing in advance an accident that may occur due to the object.

In step 704, when the reliability of the result of finding the amount of change in image is lower than a predetermined threshold, the apparatus for recognizing an object in an image may recognize that the amount of change in image is not sufficient to track the position of the object, and in step 706, execute the deep neural network algorithm on some regions in the second image where the object may be present. Specifically, the apparatus for recognizing an object in an image may estimate the position of the object based on the result of finding the amount of change in image between the first image and the second image. The apparatus for recognizing an object in an image may set a first region of interest in the second image to include the estimated position of the object, and then track the position of the object from the second image by executing the deep neural network algorithm on the first region of interest.

In step 703, in response that the object has not been detected from the first image as a result of executing the deep neural network algorithm on the first image, the apparatus for recognizing an object in an image may check that there is a motion of a new object based on the amount of change in image between the first image and the second image.

Based on confirmation that there is a motion of a new object in step 707, the apparatus for recognizing an object in an image may execute, in step 708, a deep neural network algorithm on some regions in the second image where the new object may be present. Specifically, the apparatus for recognizing an object in an image may estimate the position of the new object based on the result of finding the amount of change in image between the first image and the second image, and set a second region of interest in the second image to include the estimated position of the new object. The apparatus for recognizing an object in an image may detect the new object from the second image by executing the deep neural network algorithm on the second region of interest.

As a result of tracking the position of the object, when it is determined that the object is in a “stopped state,” the apparatus for recognizing an object in an image may increase the cycle of finding the amount of change in image (or the cycle in which the image is generated by the camera module) by a predetermined time, and thus the number of images to be processed may be reduced, thereby reducing the number of computations used.

In step 709, the apparatus for recognizing an object in an image may receive the next image after the second image, and repeat steps 702 to 708 on the received next image.

Here, the apparatus for recognizing an object in an image may track the position of the object by finding an amount of change in image for a plurality of images inputted after the second image, wherein the apparatus for recognizing an object in an image may execute the deep neural network algorithm instead of finding the amount of change in image, per a predetermined period (for example, 30 seconds), thereby accurately tracking the position of the object while reducing the number of computations used. Here, the predetermined period may be defined longer than the cycle in which the image is inputted.

The present disclosure described above may be implemented as a computer-readable code in a medium on which a program is recorded. The computer readable medium includes all types of recording devices in which data readable by a computer system can be stored. Examples of computer readable media may include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and the computer readable medium may also be implemented in the form of a carrier wave (for example, transmission over the Internet). Moreover, the computer may include a processor or a controller. Accordingly, the above detailed description should not be construed as limiting in all aspects and should be considered as illustrative. The scope of the present disclosure should be determined by reasonable interpretation of the appended claims, and all changes within the equivalent scope of the present disclosure are included in the scope of the present disclosure.

What is claimed is:

1. A method for recognizing an object in an image, the method comprising:
executing a deep neural network (DNN) algorithm which has been trained in advance to recognize an object in an image, on a first image inputted from a camera module;
finding an amount of change in image between the first image and a second image inputted from the camera module after the first image according to a predetermined cycle; and
in response that an object has been detected from the first image as a result of executing the deep neural network algorithm, tracking the position of the detected object from the second image, based on the found amount of change in image.

2. The method of claim 1, further comprising:
after the finding an amount of change in image, determining the reliability of the result of finding the amount of change in image,
wherein the tracking the position of the detected object comprises:
in response that the result of determining the reliability indicates that the reliability of the result of finding the amount of change in image is lower than a predetermined threshold,
estimating the position of the object based on the result of finding the amount of change in image, and setting a first region of interest in the second image to include the estimated position of the object; and
tracking the position of the object from the second image by executing the deep neural network algorithm on the set first region of interest.

3. The method of claim 1,
wherein the finding an amount of change in image comprises:
calculating a motion vector by using an optical flow to find the amount of change in image.

4. The method of claim 3, further comprising:
after the finding an amount of change in image, determining the reliability of the result of finding the amount of change in image,
wherein the calculating a motion vector by using an optical flow comprises:
calculating a motion vector for each pixel in the first image and the second image, based on a result of comparing the first image and the second image, and obtaining a color corresponding to the direction of the motion vector in consideration of a color predetermined for each direction; and
generating an optical flow image, based on the color corresponding to the motion vector for each pixel, and
wherein the determining the reliability comprises:
identifying an object region corresponding to the object in the optical flow image, and based on that a pixel having a color indicating an error exists above a reference value in the object region, determining that the reliability of the result of finding the amount of change in image is less than a predetermined threshold.

5. The method of claim 3, further comprising:
after the finding an amount of change in image, determining the reliability of the result of finding the amount of change in image,
wherein the calculating a motion vector by using an optical flow comprises:
calculating a motion vector for each pixel in the first image and the second image, based on a result of comparing the first image and the second image, and obtaining a color corresponding to the direction of the motion vector in consideration of a color predetermined for each direction; and
generating an optical flow image, based on the color corresponding to the motion vector for each pixel, and
wherein the determining the reliability comprises:
identifying an object region corresponding to the object in the optical flow image, and based on that the number of color types determined for the pixels in the object region is greater than or equal to a predetermined value, determining that the reliability of the result of finding the amount of change in image is less than a predetermined threshold.

6. The method of claim 1, further comprising:
after the finding an amount of change in image,
in response that the object has not been detected from the first image, checking that there is a motion of a new object based on the result of finding the amount of change in image;
based on confirmation that there is a motion of the new object as a result of the checking, setting a second region of interest in the second image to include the position of the new object; and
detecting the new object from the second image by executing the deep neural network algorithm on the set second region of interest.

7. The method of claim 1,
wherein the tracking the position of the detected object comprises:
obtaining an initial position of the object from the result of executing the deep neural network algorithm, and obtaining a moving distance of the object from the result of finding the amount of change in image; and
tracking the position of the object based on the moving distance of the object and the initial position of the object.

8. The method of claim 7, further comprising:
calculating a moving speed of the object by using the moving distance of the object and the cycle; and
in response that the moving speed of the object is greater than or equal to a predetermined speed, generating a warning notification.

9. The method of claim 1, further comprising:
tracking the position of the object by finding an amount of change in image for a plurality of images inputted after the second image, and executing the deep neural network algorithm instead of finding the amount of change in image, per a predetermined period, and
wherein the predetermined period is defined longer than the cycle.

10. The method of claim 1, further comprising:
based on determination that the object is in a “stopped state” as a result of tracking the position of the object, increasing the cycle for finding the amount of change in image by a predetermined time.

11. An apparatus for recognizing an object in an image, comprising:
an executor configured to execute a deep neural network algorithm which has been trained in advance to recognize an object in an image, on a first image inputted from a camera module, and find an amount of change in image between the first image and a second image inputted from the camera module after the first image according to a predetermined cycle; and
a processor configured to, in response that an object has been detected from the first image as a result of executing the deep neural network algorithm, track the position of the detected object from the second image, based on the found amount of change in image.

12. The apparatus of claim 11, further comprising:
a determiner configured to determine the reliability of the result of finding the amount of change in image,
wherein the processor comprises:
a setter configured to, in response that the result of determining the reliability indicates that the reliability of the result of finding the amount of change in image is lower than a predetermined threshold, estimate the position of the object based on the result of finding the amount of change in image, and set a first region of interest in the second image to include the estimated position of the object; and
a tracker configured to track the position of the object from the second image by executing the deep neural network algorithm on the set first region of interest.

13. The apparatus of claim 11,
wherein the executor is configured to calculate a motion vector by using an optical flow to find the amount of change in image.

14. The apparatus of claim 13, further comprising:
a determiner configured to determine the reliability of the result of finding the amount of change in image,
wherein the executor is configured to:
calculate a motion vector for each pixel in the first image and the second image, based on a result of comparing the first image and the second image, obtain a color corresponding to the direction of the motion vector in consideration of a color predetermined for each direction, and thereafter, generate an optical flow image based on the color corresponding to the motion vector for each pixel, and
wherein the determiner is configured to:
identify an object region corresponding to the object in the optical flow image, and based on that a pixel having a color indicating an error exists above a reference value in the object region, determine that the reliability of the result of finding the amount of change in image is less than a predetermined threshold.

15. The apparatus of claim 13, further comprising:
a determiner configured to determine the reliability of the result of finding the amount of change in image,
wherein the executor is configured to:
calculate a motion vector for each pixel in the first image and the second image, based on a result of comparing the first image and the second image, obtain a color corresponding to the direction of the motion vector in consideration of a color predetermined for each direction, and thereafter, generate an optical flow image based on the color corresponding to the motion vector for each pixel, and
wherein the determiner is configured to:
identify an object region corresponding to the object in the optical flow image, and based on that the number of color types determined for the pixels in the object region is greater than or equal to a predetermined value, determine that the reliability of the result of finding the amount of change in image is less than a predetermined threshold.

16. The apparatus of claim 11,
wherein the processor comprises:
a setter configured to, in response that the object has not been detected from the first image, check that there is a motion of a new object based on the result of finding the amount of change in image, and based on confirmation that there is a motion of the new object as a result of the check, set a second region of interest in the second image to include the position of the new object; and
a tracker configured to detect the new object from the second image by executing the deep neural network algorithm on the set second region of interest.

17. The apparatus of claim 11,
wherein the processor is configured to:
track the position of the object by finding an amount of change in image for a plurality of images inputted after the second image, and execute the deep neural network algorithm instead of finding the amount of change in image, per a predetermined period, and wherein the predetermined period is defined longer than the cycle.

18. The apparatus of claim 11,
wherein the processor is configured to:
based on determination that the object is in a “stopped state” as a result of tracking the position of the object, increase the cycle for finding the amount of change in image by a predetermined time.
